(19) United States
(12) Patent Application Publication
(10) Pub. No.: US 2003/0014756 A1
(43) Pub. Date: Jan. 16, 2003

(54) Method of enabling operation of a player device using a mobile communication device

(75) Inventor: Huw Edward Oliver, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/192,538

(22) Filed: Jul. 11, 2002

(30) Foreign Application Priority Data
Jul. 12, 2001 (GB) 0117001.8

(51) Int. Cl. H04N 7/16; H04N 7/173; H04Q 7/20

(52) U.S. Cl. 725/62; 725/123; 455/426

(57) ABSTRACT

A method of enabling player device operation using a mobile communication device involves receiving an identifier on the mobile communication device from a provider system, transmitting the identifier from the mobile communication device to a player device to permit operation of the player device, and transmitting a continual signal from the mobile communication device to the player device to permit the player device to continue operation. Appropriate player devices, mobile communication devices and provider systems are described.

### FIELD OF INVENTION

This invention relates to a method of enabling operation of a player device using a mobile communication device, a communication module to perform the method and a mobile communication device operable to perform the method and/or provided with a communication module, a method of operating a player device, a control module for a player device operable to perform the method and a player device operable to perform the method and/or provided with a control module, and a content provision means.

1. Description of Prior Art

A great deal of multimedia information is available over the Internet. This information may comprise for example, or give information in the form of music files, Internet radio stations etc., video information, text or graphical information, hereinafter referred to as “playable content”. It is known to provide mobile communication devices which are capable of, accessing the Internet, for example wireless access protocol (WAP) enabled mobile phones. It may not always be the case that the mobile communication device is able to play the playable content or may not be able to satisfactorily play the content. Where a computer may be provided with an appropriate peripheral or player software to play playable content, this is less straightforward to achieve for mobile communication devices and the content must be modified accordingly. For example, in the case WAP-enabled mobile phones, due to the necessarily small size of the phones, the type of playable content which may be accessed and played on such a phone is restricted, and in particular Internet sites accessible by WAP-enabled phones have limited text and graphical content.

### SUMMARY OF INVENTION

According to a first aspect of the invention we provide a method of enabling operation of a player device using a mobile communication device, comprising the steps of

receiving an identifier on the mobile communication device from a provider system,

transmitting the identifier from the mobile communication device to a player device to permit operation of the player device, and transmitting a continual enabling signal from the mobile communication device to the player device to permit the player device to continue operation.

The identifier may be received by the mobile communication device via a first communication apparatus using a first communication technology, and the identifier and enabling signal may be transmitted to the player device via a second communication apparatus using a second communication technology.

The mobile communication device may receive playable content from the provider system and transmit the content to the player device.

Alternatively, playable content stored on the mobile communication device may be transmitted to the player device.

The method may comprise the step of transmitting a playable content request from the mobile communication device to the provider system.

According to a second aspect of the invention we provide a mobile communications device operable to perform a method according to the first aspect of the invention.

The mobile communication device may comprise a first communication apparatus using a first communication technology, and a second communication apparatus using a second communication technology.

The second communication apparatus may have a shorter range than the first communication apparatus.

The first communication technology may be cellular radio telephony.

The second communication technology may be an infrared communication technology or a wireless local area connection communication technology.

According to a third aspect of the present invention, we provide a method of operating a player device comprising the steps of

receiving an identifier from a mobile communications device,

commencing playing playable content in response to receipt of the identifier, and

continuing to play the playable content only on continual receipt of an enabling signal from the mobile communication device.

The method may comprise the step of authenticating the identifier prior to commencing playing the playable content.

The method may comprise the step of ceasing to play the playable content if the enabling signal is not received.

The enabling signal may comprise a periodic repeated signal.

The method may comprise the step of receiving playable content to be played from the provider system.

The method may comprise the step of receiving playable content to be played from the mobile communication device.

According to a fourth aspect of the present invention, we provide a player device operable to perform a method according to the third aspect of the invention.

According to a fifth aspect of the present invention, we provide a content provision system for use with player devices adapted to play content only on receipt of an identifier, the content provision system comprising stored content, wherein the content provision system comprises a processor adapted to provide content for use by a player device only when the player device receives an identifier, and adapted to provide to a mobile communication device the identifier to enable player devices to play the provided content.

The content provision system may be operable to transmit the requested content to the player device or may be operable to transmit the requested content to the mobile communication device.

Hence, a suitable mobile communication device will be able to use a local content player device, for example a video screen to display contents downloaded from a content provider and be billed accordingly.

### BRIEF DESCRIPTION OF DRAWINGS

The invention will now be described by way of example only with reference to the accompanying drawing, wherein:

FIG. 1 is a diagrammatic illustration of a content provision means according to the present invention.

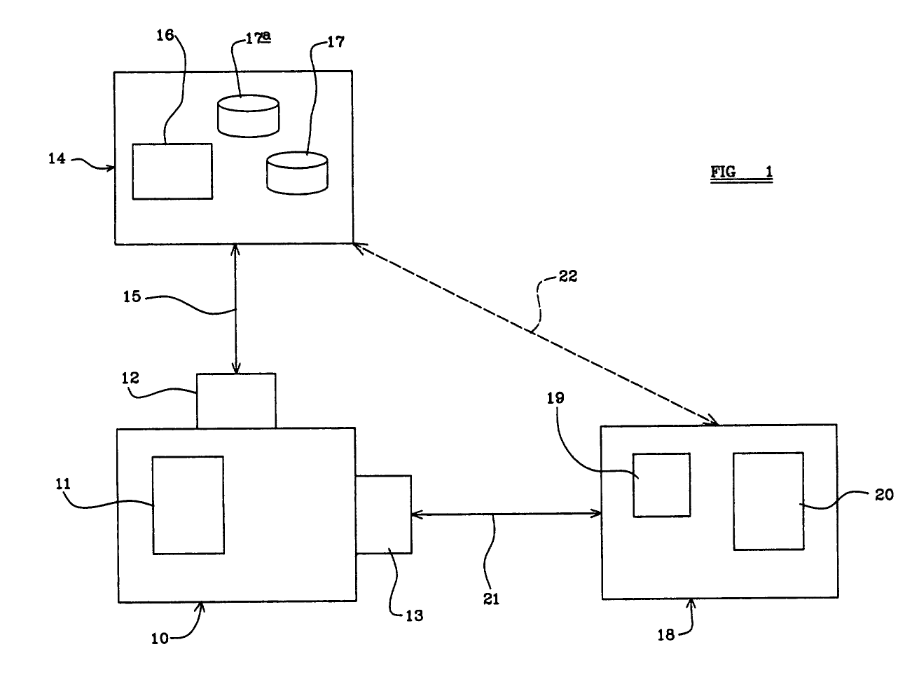

### DESCRIPTION OF PREFERRED EMBODIMENT

Referring now to the Figure, a mobile communication device 10 according to an embodiment of the present invention is shown, provided with a communication module 11, a first communication apparatus 12 using a first communication technology (first communication means) and a second communication apparatus 13 using a second communication technology (second communication means).

A provider system is generally indicated at 14, linked with the mobile communication device 10 via a communication link generally indicated by the arrows 15 via the first communication means 12. In this example, the provider system 14 is provided with an identifier generator 16 and a content storage means 17. The provider system 14 will typically comprise a server with access to appropriate memory, the server being adapted to generate the identifier and to obtain the content from memory.

A player device according to an embodiment of the present invention is shown at 18, provided with a control module 19 comprising a processor. The player device is provided with output means 20 operable to display or otherwise present requested content to a user. The player device 18 is connected to the mobile communication device 10 by a communication link generally indicated by arrows 21 via the second communication means 13.

Optionally, the player device 18 and provider system 14 may be connected by a communication link which does not pass through the mobile communication device 10, indicated by dashed arrows 22.

When a user of the mobile communication device 10 wishes to consume playable content from the provider system 14 using the player device 18, the following steps are performed in accordance with a method according to the first aspect of the invention. The mobile communication device 10 contacts the provider system 14 via the first communication means 12 and communication link 15. In this example, it is envisaged that the first communication means 12 comprises a cellular radio telephone connection which enables an Internet link to be established between the mobile communication device 10 and the provider system 14. The desired playable content held on the content storage means 17 may be selected by the user, for example from a list transmitted from the provider system 14 to the mobile communication device 10 and displayed to the user. The identifier generator 16 provides an identification number which is transmitted from the provider system to the mobile communication device 10.

To enable the selected playable content to be played on the device player 18, the identifier is then tranmitted via the second communication means 13 and communication link 21 to the player device 18, to permit the device 18 to begin playing the selected playable content in accordance with a method according to the fourth aspect of the present invention. In this example, the playable content is supplied from the content storage means 17 to the mobile communication device 10 and then to the player device 18 and comprises streamed multimedia content, but it might be envisaged that the content could be transmitted from the provider system 14 to the player device 18 by a suitable connection 22, for example a broad-band communication link with a higher capacity than the first commmunication link 15 and the second communication link 21. To establish this connection, the player device 18 may open communication with the provider system 14, passing back the identifier originally provided by the provider system 14 to obtain the selected content. Alternatively, the content might be stored on the mobile communication device and passed to the player device 18, or the player device 18 may be provided with a content storage means which is playable on receipt of any suitable identifier from the provider system 14 (in this case either synchronisation of some kind between the content lists of the of the provider system 14 and the player device 18 is desirable, or the identifier provided by the provider system 14 will be such as to allow the specific choice of content to be selected by the user of the mobile communication device 10 from the alternatives offered by the player device 18).

To enable the player device 18 to continue playing the desired content, a continual enabling signal is generated by the communication module 11 of the mobile communication device 10 and transmitted to the player device 18. In this example, the enabling signal comprises a “heart beat” protocol, comprising regular and frequent request/response exchanges, in which the player device 18 tranmits a simple request signal and the mobile communication device transmits a simple response. While this enabling signal is maintained, the player device 18 will continue to play the content, making it available to the user on the output means 20. If the enabling signal is not received, for example if the second communication link 21 is broken, then the player device 18 will cease to play the playable content. In this example, ‘continual’ is taken to mean ‘regularly repeated’, but it will be apparent that the enabling signal could comprise a ‘continuous’, i.e. uninterrupted, signal from the mobile communication device 10.

In the preferred example, once the enabling signal is not received and the player device 18 ceases to play the playable content, the identifier will be invalidated (for example, no longer recognised by the player device), and for the player device 18 to operate again, a new identifier will have to be requested from the provider system 14. Alternatively, it may be envisaged that for certain applications, the identifier will remain valid and the player device 18 would resume playing the content once the second communication link 21 and enabling signal were re-established. In this or other arrangements, it may be desirable for the player device 18 to have the ability to check the validity of identifiers directly with the provider system 14 independently of the mobile communication device 10.

In the present example, the provider system 14 also comprises a billing information storage means 17a. When the link between the mobile communication device 10 and provider system 14 is established, the mobile communication device 10 may transmit a suitable device identifier, for example a mobile phone's SIM card number. The provider system 14 will process information to enable the user to be billed for the playable content and use of the player device 18. For example, the provider system 14 may log the identifier, the type of content requested and the time at which streaming of the playable content started. When the second communication link 21 and/or enabling signal is interupted and the player device 18 ceases to play the content, the time at which the second communication link 21 was broken may be transmitted by the mobile communication device 10 and/or player device 18 to the provider system 14 to be logged to provide an appropriate time charge.

In the present example, the second communication means 13 preferably comprises a short-range link, such as an infrared communication link, or a wireless local area network link (e.g. using a known short range wireless protocol such as Bluetooth), or any other appropriate link as desired.

By using the present invention, a user will be able to use a local player device, for example a video display, to play the requested downloaded playable content, for example a video, whilst the user and his mobile communication device 10 remain in the vicinity of the player device 18. The user then be billed for the downloaded content and/or the use of the player device 18. It would be envisaged that the player device 18 may be a publicly available device, for example a video screen and player at an airport terminal.

Although as discussed above it is preferred that once the second communication link 21 is broken, the identifier transmitted by the provider system 14 ceases to be valid, it might be envisaged that as a user and mobile communication device 10 pass a plurality of different player devices 18, the identifier remains valid and a second communication link 21 and enabling signal is established between each successive player device 18 and the mobile communication device 10. Thus, as for example a user walks through an airport terminal provided with a plurality of display devices 18, the requested content may be displayed on successive display devices 18 as the mobile communication device 10 comes into range of each display device 18.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of enabling player device operation using a mobile communication device, comprising the steps of
receiving an identifier on the mobile communication device from a provider system,
transmitting the identifier from the mobile communication device to a player device to permit operation of the player device, and
transmitting a continual signal from the mobile communication device to the player device to permit the player device to continue operation.

2. A method according to claim 1 wherein the identifier is received by the mobile communication device via a first communication apparatus using a first communication technology, and the identifier and enabling signal are transmitted to the player device via a second communication apparatus using a second communication technology.

3. A method according to claim 1 further comprising the steps of the mobile communication device receiving playable content from the provider system and transmitting the playable content to the player device.

4. A method according to claim 1 further comprising the step of transmitting playable content stored on the mobile communication device to the player device.

5. A method according to claim 1 further comprising the initial step of transmitting a request for playable content from the mobile communication device to the provider system.

6. A mobile communications device having a communication module adapted to receive an identifier from a provider system, transmit the identifier to a player device to permit operation of the player device, and to transmit a continual signal from the mobile communication device to the player device to permit the player device to continue operation.

7. A mobile communication device according to claim 6 comprising a first communication apparatus using a first communication technology and a second communication apparatus using a second communication technology.

8. A mobile communication device according to claim 7 wherein the second communication apparatus has a shorter range than the first communication apparatus.

9. A mobile communication device according to claim 7 wherein the first communication technology is cellular radio telephony.

10. A mobile communication device according to claim 7 wherein the second communication technology is an infrared communication technology.

11. A mobile communication device according to claim 7 wherein the second communication technology is a wireless local area networking technology.

12. A mobile communication device comprising cellular telephony apparatus, a local networking communication apparatus and a processor, the processor being adapted to control the mobile communication device to receive an identifier from a provider system through the cellular telephony apparatus, transmit the identifier to a player device through the local networking communication apparatus to permit operation of the player device, and to transmit intermittent signals from the mobile communication device through the local networking communication apparatus to the player device to permit the player device to continue operation.

13. A method of operating a player device comprising the steps of:
receiving an identifier from a mobile communications device,
commencing playing playable content in response to receipt of the identifier, and
continuing to play the playable content only on continual receipt of an enabling signal from the mobile communication device.

14. A method according to claim 13 further comprising the step of authenticating the identifier prior to commencing playing the playable content.

15. A method according to claim 13 further comprising the step of ceasing to play the content if an enabling signal is not received.

16. A method according to claim 15 wherein the enabling signal comprises a periodic repeated signal.

17. A method according to claim 13 further comprising the steps of receiving the playable content to be played from a provider system.

18. A method according to claim 13 further comprising the step of receiving playable content to be played from the mobile communication device.

19. A player device having a processor, a communication apparatus and a content player, the processor being adapted to control the player device to receive an identifier from a mobile communications device through the communication apparatus, to commence playing playable content over the content player in response to receipt of the identifier, and to continue to play the playable content only on continual receipt of an enabling signal from the mobile communication device.

20. A player device according to claim 19 wherein the communication apparatus uses a short range communication technology.

21. A player device according to claim 20 wherein the communication technology is an infrared communication technology.

22. A player device according to claim 20 wherein the communication technology is a wireless local area networking technology.

23. A content provision system for use with player devices adapted to play content only on receipt of an identifier, the content provision system comprising stored content, wherein the content provision system comprises a processor adapted to provide content for use by a player device only when the player device receives an identifier, and adapted to provide to a mobile communication device the identifier to enable player devices to play the provided content.

24. A content provision system according to claim 23 wherein the system is operable to transmit the requested content to the player device.

25. A content provision system according to claim 23 wherein the system is operable to transmit the requested content to the mobile communication device.

26. A content playing system comprising: a content provision system with a memory having stored content, a processor adapted to provide content for use by a player device only when the player device receives an identifier, and adapted to provide to a mobile communication device the identifier to enable player devices to play the provided content; and one or more player devices adapted to play the content on receipt of the identifier.
